(19) United States
(12) Patent Application Publication
(10) Pub. No.: US 2025/0327977 A1
(43) Pub. Date: Oct. 23, 2025

(54) Hybrid Fiber and Electrical Connector and Adapter Using Vertical Aligned Interface

(71) Applicant: Panduit Corp., Tinley Park, IL (US)

(72) Inventors: Yu Huang, Orland Park, IL (US); Ryan N. Murphy, Monee, IL (US); Jose M. Castro, Naperville, IL (US); Thomas M. Sedor, Orland Park, IL (US); Masud Bolouri-Saransar, Orland Park, IL (US); Frank J. Dundek, New Lenox, IL (US); Satish I. Patel, Roselle, IL (US); Bulent Kose, Burr Ridge, IL (US)

(73) Assignee: Panduit Corp., Tinley Park, IL (US)

(21) Appl. No.: 19/098,628

(22) Filed: Apr. 2, 2025

Related U.S. Application Data
(60) Provisional application No. 63/636,914, filed on Apr. 22, 2024.

(51) Int. Cl. G02B 6/38

(52) U.S. Cl. CPC G02B 6/3825; G02B 6/3849; G02B 6/3893; G02B 6/3897

(57) ABSTRACT

A hybrid fiber optic connector and adapter assembly is provided as a solution for providing proper polarity when connecting hybrid cables that include both optical fiber and electrical wire together using connector and adapter assemblies.

### CROSS-REFERENCE TO RELATED APPLICATION(S)

This application claims benefit to U.S. Provisional Patent Application No. 63/636,914, filed on Apr. 22, 2024, the entirety of which is hereby incorporated by reference herein.

### TECHNICAL FIELD

The application relates to a hybrid fiber and electrical connector and adapter assembly that builds and improves upon existing fiber connector and adapter systems.

### BACKGROUND

Traditional connectors are often limited to either electrical power transmission or optical data communication, requiring the use of multiple connectors and cables for various functions in diverse applications. The demand for streamlined, versatile connector solutions has steadily grown across multiple industries and applications.

To address this need, previous work has seen the development of hybrid connectors that facilitate the coexistence of optical fiber and electrical conductors. However, these existing hybrid connectors often tend to be bulky and complex to manufacture. Therefore, there is a desire to create a compact hybrid connector with the size and footprint of a standard fiber optic connector.

One challenge with many existing hybrid connectors is the potential for polarity issues, as the polarity of fiber and electrical cables may differ. For example, FIG. 1A shows a first fiber optic transceiver 10 and a second fiber optic transceiver 20 that are connected by a duplex fiber patch cord 30. In this system configuration, the fiber optic cords 31, 32 of the duplex fiber patch cord 30 must remain parallel to maintain correct polarity, ensuring that the transmitter of the first fiber optic transceiver 10 always connects to the receiver of the second fiber optic transceiver 20 at the other end, and vice versa. The key structures of fiber optic connectors prevent flipping, which helps maintain the correct polarity of the fiber optic connectors.

However as shown in FIG. 1B, when attempting to provide electrical power from the first fiber optic transceiver 10 to the second fiber optic transceiver 20 via a duplex hybrid patch cord 40, the two electrical wires 41, 42 of the duplex hybrid patch cord 40 must cross each other to maintain the correct electrical polarity for the two transceivers 10, 20. So maintaining the proper polarity of the electrical lines in a hybrid cable becomes a new issue needing to be considered when installing such duplex hybrid patch cords 40.

When a second duplex fiber optic patch cord 30b is added to the first duplex fiber optic patch cord 30a to form a combination fiber optic link, as illustrated in FIG. 2A, the correct polarity for the fiber optic cords 31a, 32a, 31b, 32b may still be maintained. Nevertheless, when a second duplex hybrid patch cord 40b is added to the first duplex hybrid patch cord 40a to form a combination hybrid link, as seen in FIG. 2B, the second duplex hybrid patch cord 40b will have the opposite polarity to the second fiber optic transceiver 20 at its respective end, as shown by the mis-matched polarity at the connections 50 made at the second fiber optic transceiver 20, leading to a loss of correct polarity preservation for the electrical wires 41a, 42a, 41b, 42b.

This issue may exist for all the electrical patch cords whose connectors are aligned horizontally. Therefore, the present solution looks to provide a hybrid connector and adapter system that addresses this polarity issue.

### SUMMARY

Disclosed herein are exemplary new hybrid connector and adapter systems that are configured to provide a solution for misaligning proper polarity when connecting hybrid cables together using connector and adapter assemblies.

A hybrid cable connector is disclosed, the hybrid cable connector comprising a first hybrid connector including a first wall surface, the first wall surface including a first pair of slots, a second hybrid connector including a second wall surface, the second wall surface including a second pair of slots, a first pair of conductive plates positioned within the first pair of slots, a second pair of conductive plates positioned within the second pair of slots, and a push-pull clip configured to hold the first hybrid connector and the second hybrid connector, the push-pull clip comprising an insulative protector configured to cover over at least a portion of the first hybrid connector and at least a portion of the second hybrid connector.

A hybrid cable connector adapter is disclosed, the hybrid adapter comprising a first side housing comprising a first opening configured to install a first hybrid connector and a second opening configured to install a second hybrid connector, a second side housing comprising a third opening configured to install a third hybrid connector and a fourth opening configured to install a fourth hybrid connector, a first set of leaf springs configured to: contact a first pair of conductive plates included on the first hybrid connector installed into the first opening of the first side housing; and contact a third pair of conductive plates included on the third hybrid connector installed into the third opening of the second side housing, a second set of leaf springs configured to: contact a second pair of conductive plates included on the second hybrid connector installed into the second opening of the first side housing, and contact a fourth pair of conductive plates included on the fourth hybrid connector installed into the fourth opening of the second side housing, and a first fiber optic transmission tunnel configured to transfer an optical signal from the first hybrid connector to the third hybrid connector, and a second fiber optic transmission tunnel configured to transfer an optical signal from the second hybrid connector to the fourth hybrid connector.

A hybrid cable connector is disclosed, the hybrid cable connector comprising a duplex connector housing including a first connector housing and a second connector housing; a first pair of conductive plates attached to a first wall of the first connector housing; a second pair of conductive plates attached to a first wall of the second connector housing; and a push-pull clip including an insulative protector configured to cover over at least a portion of the first wall of the first connector housing and at least a portion of the first wall of the second connector housing.

A hybrid cable connector adapter is disclosed, the hybrid cable connector adapter comprising a first side housing and a second side housing, the first side housing including a first pair of openings for installing a first duplex connector and the second side housing including a second pair of openings for installing a second duplex connector; a first set of leaf springs configured to: contact a first pair of conductive plates included on a first connector installed into a first opening in the first pair of openings; and contact a first pair of conductive plates included on a first connector installed into a first opening in the second pair of openings; a second set of leaf springs configured to: contact a second pair of conductive plates included on a second connector installed into a second opening in the first pair of openings; and contact a second pair of conductive plates included on a second connector installed into a second opening in the second pair of openings; and a set of fiber optic transmission tunnels configured to transfer an optical signal from the set of connectors installed in the first pair of openings to the set of connectors installed in the second pair of openings.

A detailed description of these and other non-limiting exemplary embodiments of the hybrid cable connector and adapter assemblies is set forth below together with accompanying drawings.

### BRIEF DESCRIPTION OF THE DRAWINGS

FIG. 1A illustrates an exemplary system diagram including a fiber cable assembly including only fiber optical lines.

FIG. 1B illustrates an exemplary system diagram including a hybrid fiber cable assembly including both fiber optical lines and electrical transmission lines.

FIG. 2A illustrates an exemplary system diagram showing how proper polarity is maintained when coupling two sets of duplex fiber optic patch cords.

FIG. 2B illustrates an exemplary system diagram showing how improper polarity may result for an electrical transmission line when coupling two sets of duplex hybrid patch cords.

FIG. 3A illustrates an exemplary system diagram including a duplex hybrid connector and adapter assembly configured to provide proper polarity for its electrical connections, according to an embodiment of the present disclosure.

FIG. 3B illustrates an exemplary system diagram including a hybrid connector and adapter assembly configured to provide proper polarity for its electrical connections when two sets of duplex hybrid cables are connected, according to an embodiment of the present disclosure.

FIG. 4A illustrates a perspective view of an exemplary duplex hybrid connector that may be configured to provide proper polarity for electrical connections, according to an embodiment of the present disclosure.

FIG. 4B illustrates a top-down view of the duplex hybrid connector from FIG. 4A, according to an embodiment of the present disclosure.

FIG. 4C illustrates an exploded perspective view of the duplex hybrid connector from FIG. 4A, according to an embodiment of the present disclosure.

FIG. 4D illustrates a front-side view of the duplex hybrid connector from FIG. 4A, according to an embodiment of the present disclosure.

FIG. 4E illustrates a cross-sectional view of the duplex hybrid connector from FIG. 4B taken along the line 4E-4E, according to an embodiment of the present disclosure.

FIG. 5A illustrates an exemplary second hybrid connector that may be included in the duplex hybrid connector shown in FIG. 4A, according to an embodiment of the present disclosure.

FIG. 5B illustrates an exemplary first hybrid connector that may be included in the duplex hybrid connector shown in FIG. 4A, according to an embodiment of the present disclosure.

FIG. 6A illustrates a perspective view of an exemplary hybrid adapter that may receive the duplex hybrid connector shown in FIG. 4A, according to an embodiment of the present disclosure.

FIG. 6B illustrates a front-side view of the hybrid adapter shown in FIG. 6A, according to an embodiment of the present disclosure.

FIG. 6C illustrates a top-down view of the hybrid adapter shown in FIG. 6A, according to an embodiment of the present disclosure.

FIG. 7 shows an exploded perspective view of the hybrid adapter shown in FIG. 6A, according to an embodiment of the present disclosure.

FIG. 8A illustrates the duplex hybrid connector in a pre-installation state prior to being inserted into the hybrid adapter, according to an embodiment of the present disclosure.

FIG. 8B illustrates the duplex hybrid connector in an installed state after being inserted into the hybrid adapter, according to an embodiment of the present disclosure.

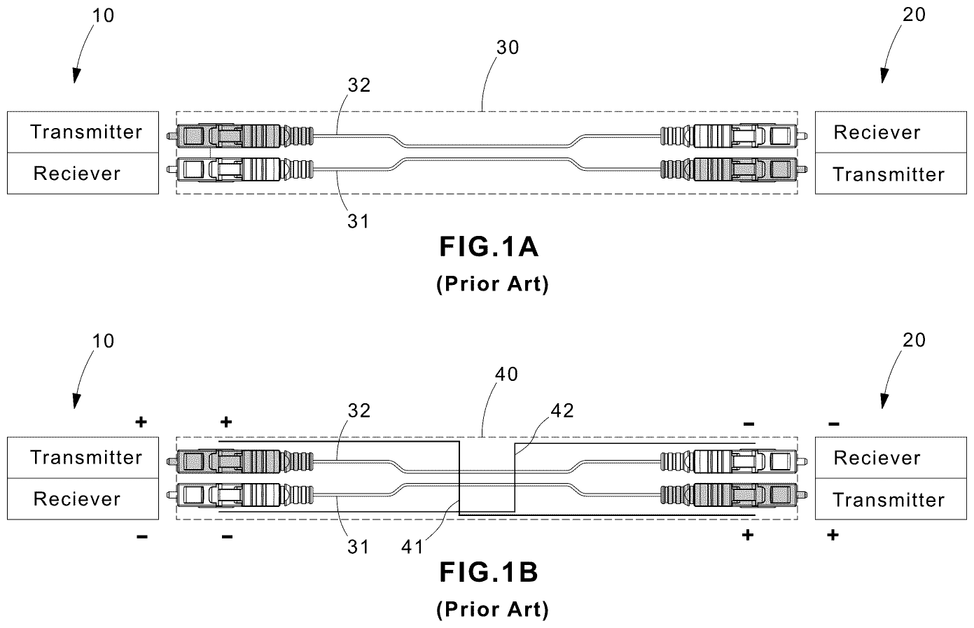

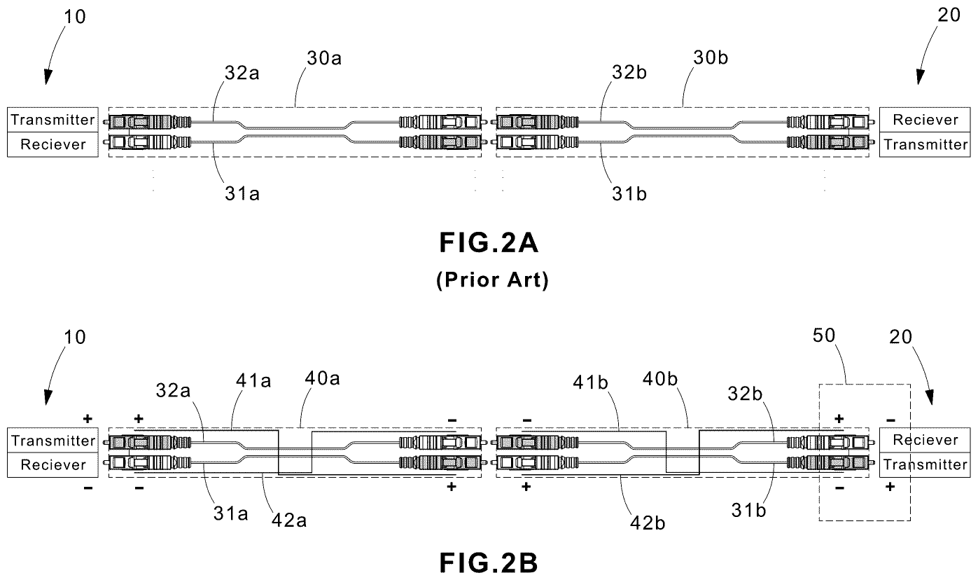

### DETAILED DESCRIPTION

Detailed and non-limiting embodiments of the hybrid connector and adapter assembly are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

The hybrid connector and adapter assembly (e.g., the connector is configured to install into the adapter) disclosed herein is a system that provides the benefits of hybrid data and power delivery by giving power and fiber optic connectivity to, for example, intermedia and end devices in equipment rooms, zones, and work areas, with low cost, simple field termination, and reliable optical communications.

The demand for streamlined, versatile connector solutions has steadily grown across multiple industries and applications. The hybrid connector and adapter assembly disclosed herein has been developed in response to these evolving needs, where the hybrid connector and adapter assembly provides an innovative solution, effectively overcoming the constraints of traditional connectors. This forward-thinking hybrid connector and adapter assembly seamlessly integrates the capabilities of transmitting electric power and optical data over a single unified interface, offering numerous compelling advantages.

The hybrid connector and adapter assembly significantly reduces installation costs by eliminating the need for multiple connectors, complex cabling, and the associated installation challenges. Additionally, it simplifies infrastructure, resulting in cleaner and more efficient cable management. Another notable benefit is its flexibility in system design, giving engineers and system designers the freedom to customize systems to meet specific requirements and constraints. The applicability of such a connector extends to a wide range of sectors, particularly in scenarios where electrical power delivery and high-speed data communication are essential. This includes cutting-edge domains such as smart grid systems, industrial automation, data centers, and telecommunications networks.

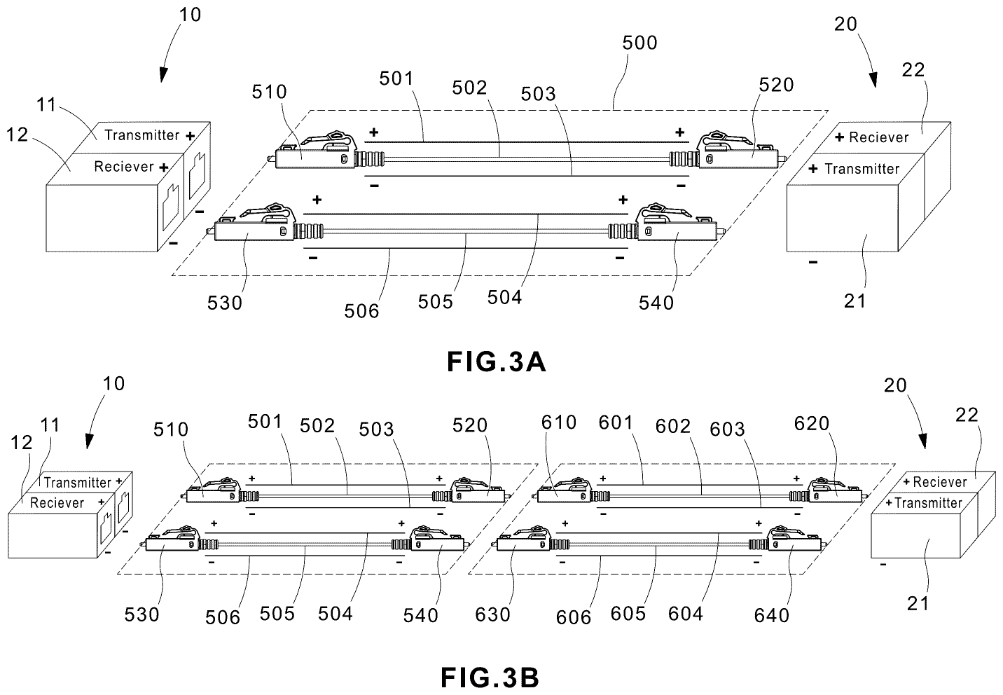

In this disclosure, the novel design for the hybrid connector and hybrid adapter is rooted in its vertical, stacked, architecture design which is worked into the compact dimensions of existing fiber connectors and adapters. For example, FIG. 3A shows an exemplary system polarity scheme for vertically aligned patch cords including one duplex hybrid patch cord 500, according to an embodiment of this disclosure. The duplex hybrid patch cord includes a first hybrid cable for connecting two hybrid connectors 510, 520 at opposite ends, the first hybrid cable including a first optical fiber 502, a first conductor wire 501 and a second conductor wire 503. The duplex hybrid patch cord also includes a second hybrid cable for connecting two hybrid connectors at opposite ends, the second hybrid cable including a second optical fiber 505, a third conductor wire 504 and a fourth conductor wire 506. The hybrid connectors 510, 530 may together form a duplex hybrid connector at the first end, while the hybrid connectors 520, 540 may together form a duplex hybrid connector at the second end.

FIG. 3B shows an exemplary system polarity scheme for vertically aligned patch cords including two duplex hybrid patch cords, a first duplex hybrid patch cord 500 and a second duplex hybrid patch cord 600, according to an embodiment of this disclosure. The first duplex hybrid patch cord 500 is the same as described in FIG. 3A. The second duplex hybrid patch cord 600 includes the same components as the first duplex hybrid patch cord 500, namely a first hybrid cable for connecting two hybrid connectors at opposite ends, the first hybrid cable including a first optical fiber 602, a first conductor wire 601 and a second conductor wire 603. The second duplex hybrid patch cord also includes a second hybrid cable for connecting two hybrid connectors at opposite ends, the second hybrid cable including a second optical fiber 605, a third conductor wire 604 and a fourth conductor wire 606. The hybrid connectors 610, 630 may together form a duplex hybrid connector at the first end, while the hybrid connectors 620, 640 may together form a duplex hybrid connector at the second end.

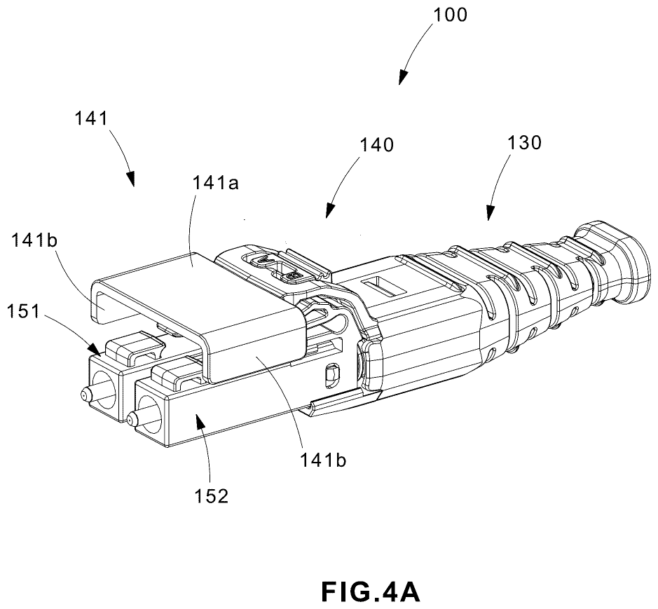

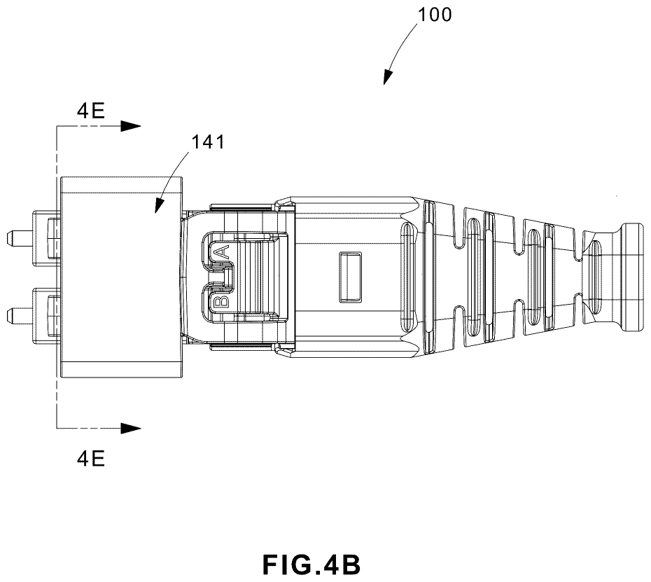

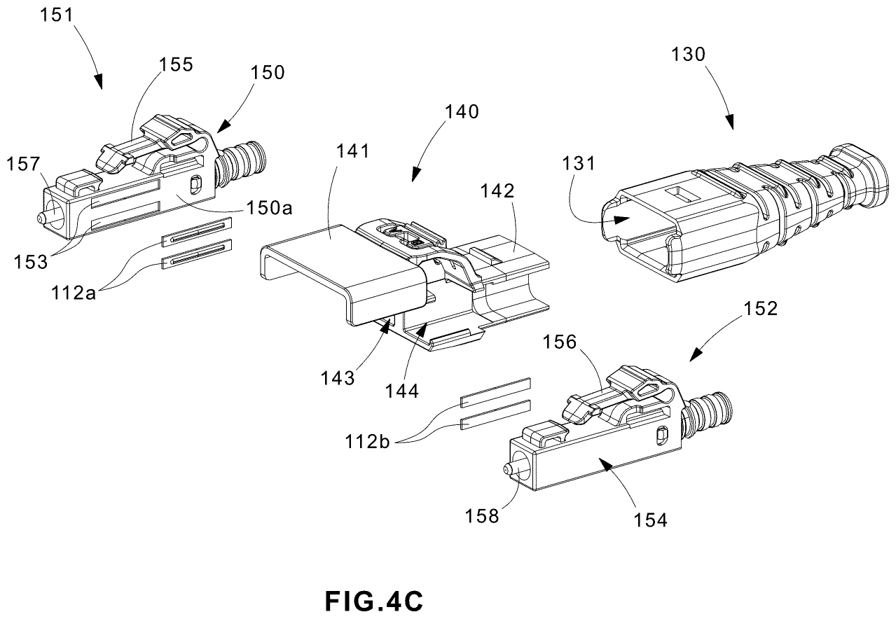

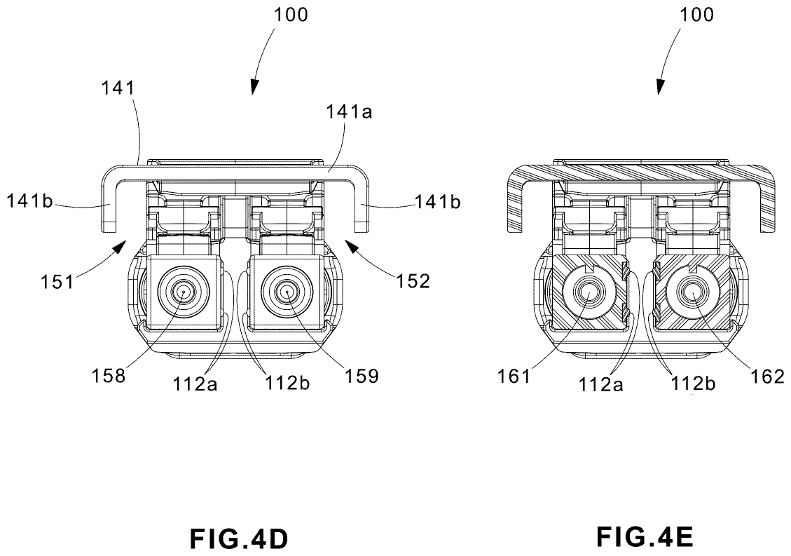

FIG. 4A shows a perspective view of an exemplary duplex hybrid connector 100, where the duplex hybrid connector 100 may be one of the duplex hybrid connectors described in the system polarity schemes illustrated in FIGS. 3A and 3B. The duplex hybrid connector 100 includes a first hybrid connector 151 and a second hybrid connector 152, a push-pull clip 140 for holding the first hybrid connector 151 and the second hybrid connector 152, and a boot 130. More specifically, the push-pull clip 140 includes a first housing opening 143 configured to hold the first hybrid connector 151, and a second housing opening 144 configured to hold the second hybrid connector 152, as shown, for example, in FIG. 4C.

The push-pull clip 140 includes an insulative protector 141 configured to cover at least a portion of a top portion of the first hybrid connector 151 and the second hybrid connector 152, as seen in the top-down view of the duplex hybrid connector shown in FIG. 4B. The insulation protector 141 may be made from an electrically insulative material such as rubber, plastic, or other polymer having insulation characteristics. So, for example, the insulative protector 141 may include a flat cover portion 141a configured to cover at least the latches 155, 156 included on the top portion of the first hybrid connector 151 and the second hybrid connector 152, respectively. The insulative protector 141 may further include side portions 141b that come down perpendicular to the flat cover portion 141a, where the side portions 141b may cover at least a portion of the sides to the first hybrid connector 151 and the second hybrid connector 152. For example, the side portions 141b may cover at least a portion, or all, of the latches 155, 156 that are included at the top portion of the first hybrid connector 151 and the second hybrid connector 152. As described in further detail below, the insulative protector 141 may further be utilized to cover additional components.

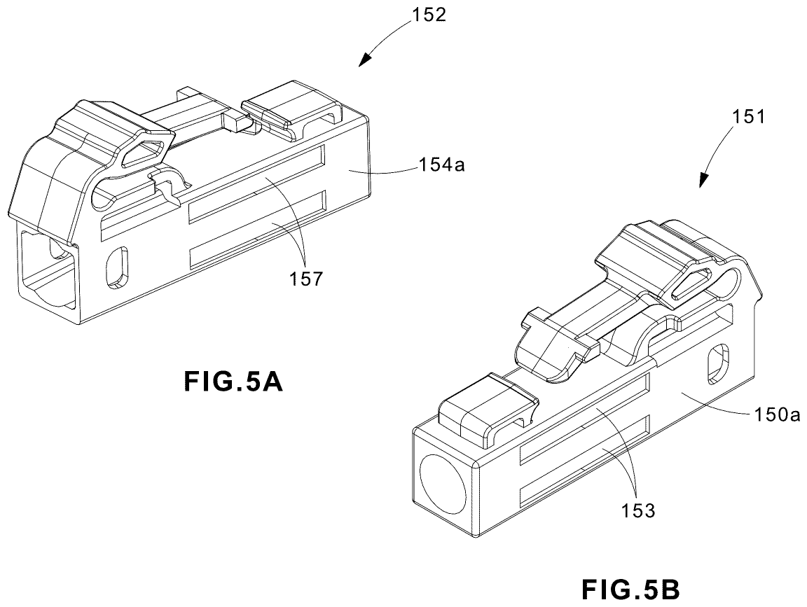

FIG. 4C shows an exploded perspective view of the duplex hybrid connector 100, further showing conductive plates 112 that are installed onto the first hybrid connector 151 and the second hybrid connector 152. More specifically, a first pair of conductive plates 112a are installed into holding slots 153 located on an inner surface 150a of a housing 150 of the first hybrid connector 151, as seen in more detail in the perspective view of the first hybrid connector 151 shown in FIG. 5B. Similarly, a second pair of conductive plates 112b are installed into holding slots 157 located on an inner surface 154a of a housing 154 of the second hybrid connector 152, as seen in more detail in the perspective view of the second hybrid connector 152 shown in FIG. 5A.

These conductive plates 112a, 112b are configured to electrically couple with the electrical conductor wires in the hybrid cable that are connected to the first hybrid connector 151 and the second hybrid connector 152, respectively. To ensure electrical safety, the conductive plates 112 are shielded by the insulative protector 141 included on the push-pull clip 140, where the insulative protector 141 is integrated into a push-pull clip 140 to prevent user contact with the conductive plates 112a, 112b. In addition to the insulative protector 141 positioned on top of the push-pull clip 140, according to some embodiments an additional insulative protector may be further positioned at the bottom of the duplex hybrid connector 100 to further safeguards users from electrical voltage.

FIG. 4D shows a front-side view of the duplex hybrid connector 100. In this front-side view, the first pair of conductive plates 112a are shown to protrude out from the inner surface 150a of the housing 150 of the first hybrid connector 151, and the second pair of conductive plates 112b are shown to protrude out from the inner surface 154a of the housing 154 of the second hybrid connector 152. A first ferrule 158 included in the first hybrid connector 151 and configured to transmit an optical signal from the hybrid cable, is also shown. A second ferrule 159 included in the second hybrid connector 152 and configured to transmit an optical signal from the hybrid cable, is also shown. As further shown by the front-side view of the duplex hybrid connector 100, the flat cover portion 141a and the side portions 141b of the insulative protector 141, are configured to prevent finger access into the top sides and inner surfaces 150a, 154a of the first hybrid connector 151 and the second hybrid connector 152, respectively.

FIG. 4E shows a cross-sectional view into the duplex hybrid connector 100 taken along the line 4E-4E from the duplex hybrid connector shown in FIG. 4B. In this cross-sectional view of the duplex hybrid connector 100 shown in FIG. 4E, a profile of the first pair of conductive plates 112a and the second pair of conductive plates 112b is better shown to include a raised portion that protrudes out from the inner surface 150a and the inner surface 154a, respectively. A fiber component 161 included in the first hybrid connector 151 and configured to transmit an optical signal from the hybrid cable, is also shown. Also shown is a fiber component 162 included in the second hybrid connector 152 and configured to transmit an optical signal from the hybrid cable.

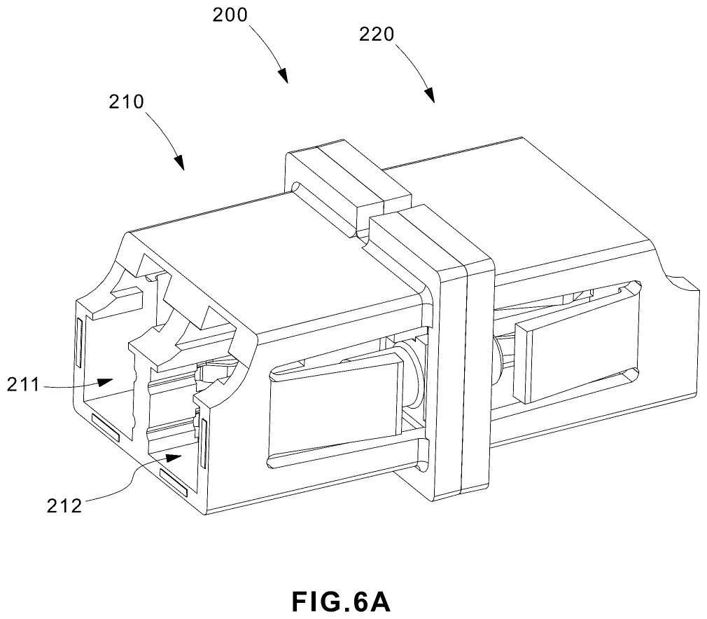

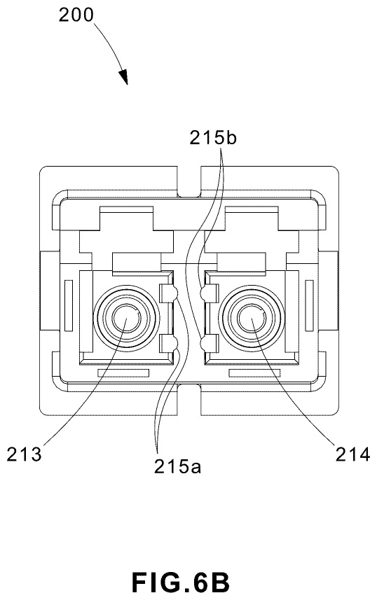

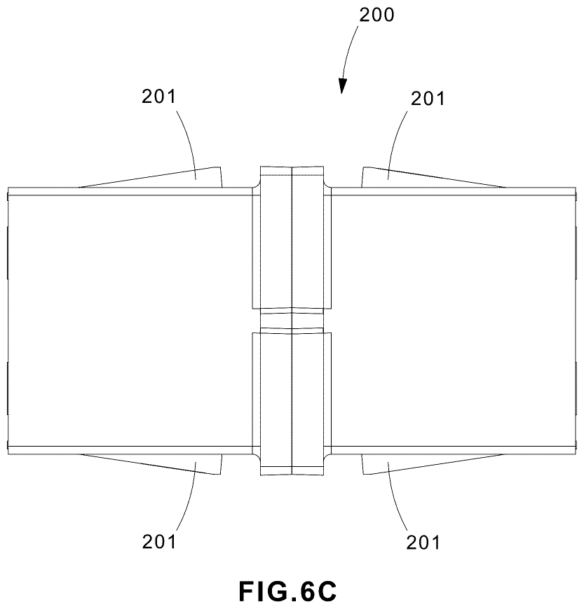

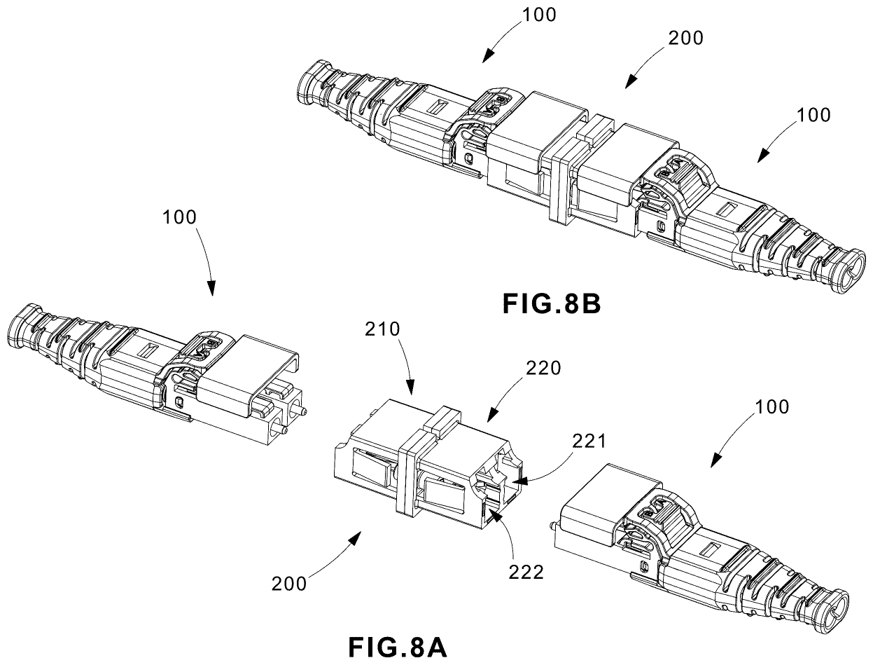

FIG. 6A shows a perspective view of a hybrid adapter 200, where the duplex hybrid connector 100 is configured to be installed into both sides of the hybrid adapter 200. The duplex hybrid adapter 200 includes a first half housing 210 and a second half housing 220 that are essentially mirrors of each other, where the hybrid adapter 200 is configured to install the duplex hybrid connector 100 into openings 211, 212 of the first half housing 210, and transfer transmission of the optical fiber and the electrical power transmission from the hybrid cable to the duplex hybrid connector 100 installed into openings 221, 222 (see FIG. 8A) of the second half housing 220.

FIG. 6B is a front-side view of the hybrid adapter 200, showing the side with the first half housing 210. From this view, the hybrid adapter 200 is shown to include a first split sleeve 213 for receiving the first ferrule 158, and a second split sleeve 214 for receiving the second ferrule 159. The hybrid adapter 200 also includes a first pair of slots 215a for receiving the first pair of conductive plates 112a, and a second pair of slots 215b for receiving the second pair of conductive plates 112b. FIG. 6C shows a top-down view of the hybrid adapter 200, which better shows the placement of latches 201 on the sides of the first half housing 210 and the second half housing 220. The latches 201 may enable removal of the duplex hybrid connectors 100 that are installed into the hybrid adapter 200 when the latches 201 are compressed in.

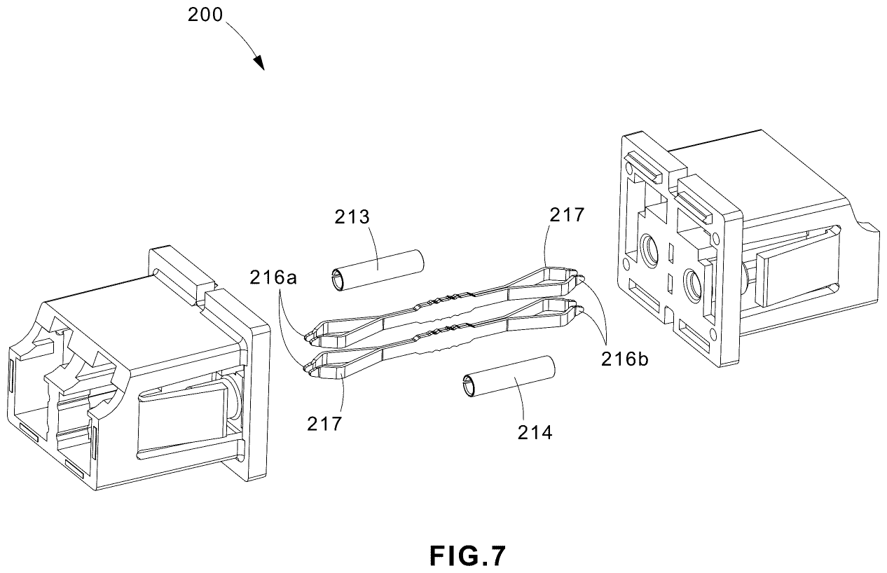

FIG. 7 shows an exploded perspective view of the hybrid adapter 200, showing certain internal components. From this view, the first split sleeve 213 and the second split sleeve 214 are shown in more detail. As described, the first split sleeve 213 and the second split sleeve 214 are configured to function as transmission tunnels for transferring the optical fiber data transmission between the duplex hybrid connector 100 installed into the first half housing 210 to the duplex hybrid connector 100 installed into the second half housing 220. Also shown in FIG. 7 are sets of vertically stacked leaf springs 216a, 216b. The stacked leaf springs 216a are configured to be installed into the slots 215a, and the stacked leaf springs 216b are configured to be installed into the slots 215b, according to the orientation shown in FIG. 7. The stacked leaf springs 216a, 216b are configured to transfer the electrical power transmission between the duplex hybrid connector 100 installed into the first half housing 210 to the duplex hybrid connector 100 installed into the second half housing 220. For example, the stacked leaf springs 216a may make contact with the conductive plates 112a included in the first hybrid connector 151, and the stacked leaf springs 216b may make contact with the conductive plates 112b in the second hybrid connector 152. In particular, the stacked leaf springs 216a, 216b may include a raised portion 217, where the raised portion 217 is configured to protrude out to make contact with the conductive plates 112a, 112b.

FIG. 8A shows a first duplex hybrid connector 100 and a same second duplex hybrid connector 100 in a pre-installation state prior to being installed into the hybrid adapter 200. FIG. 8B shows the first duplex hybrid connector 100 and the second duplex hybrid connector 100 in an installed state, where the first duplex hybrid connector 100 is installed into the first half housing 210 of the hybrid adapter 200, and the second duplex hybrid connector 100 is installed into the second half housing 220 of the hybrid adapter 200.

When the duplex hybrid connector 100 are installed into the hybrid adapter 200 as shown in FIG. 8B, the electrical transmission from the first duplex hybrid patch cord 500 may be successfully transferred to the second duplex hybrid patch cord 600 while maintaining proper polarity, in a system as shown in FIG. 3B. So by utilizing the hybrid adapter 200 to connect the duplex hybrid connectors 100 that are carrying the first duplex hybrid patch cord 500 and the second duplex hybrid patch cord 500, the conductor wires 501, 503, 504, 506 in the first duplex hybrid patch cord 500 may be transmitted through the hybrid adapter 200 to the conductor wires 601, 603, 604, 606 in the second duplex hybrid patch cord 600 while maintaining proper polarity in the system shown in FIG. 3B.

For example, when the duplex hybrid connector 100 is inserted into the hybrid adapter 200, there is good contact between the conductive plates 112a, 112b included in the duplex hybrid connector 100 and the leaf springs 216a, 216b included in the hybrid adapter 200, so that electrical power from the duplex hybrid connector 100 installed into the first half housing 210 of the hybrid adapter 200 may be transferred to the duplex hybrid connector 100 installed into the second half housing 220 of the hybrid adapter.

Although the first hybrid connector 151 and the second hybrid connector 152 and the corresponding hybrid adapter 200 are shown to be in the LC connector/adapter form factor in the embodiments disclosed herein, the features of the present hybrid connector and adapter assembly may be applied to other fiber connector/adapter types such as for SN, SC, or CS types. The features of the disclosed hybrid connector and adapter assembly may also be applied to multi fiber connector/adapter types such as for MPO or MTP types.

A hybrid fiber and electrical connector and adapter system containing two duplex fiber optic connectors and a duplex fiber optic adapter is disclosed, wherein the two pairs of fiber optic connectors can be connected to each other via the fiber optic adapter, wherein the duplex connector has at least two conductors at the middle connector housing surface shared by both fiber optic connectors, whereby one conductor is on top of the other conductor, wherein the duplex fiber optic adapter has at least two conductors in the middle of the adapter housing, whereby one conductor is on top of the other conductor, wherein the conductors of the connector will contact the conductors of the adapter after the connector is inserted into the adapter.

The hybrid fiber and electrical connector and adapter system may, for example, utilize duplex LC, CS, SN, or SC types of connectors for at least one fiber optic connectors.

The hybrid fiber and electrical connector and adapter system, whereby at least one connector is a multifiber MTP/MPO type is also disclosed.

The hybrid fiber and electrical connector and adapter system, wherein an insulative protector is integrated into the top of the duplex connector to protect the user from touching the conductor on the connector, and a gap exists between the protector and the hybrid connector to allow it to be inserted into the hybrid adapter is also disclosed.

The hybrid fiber and electrical connector and adapter system, wherein an insulative protector is integrated into the bottom of the duplex connector to protect the user from touching the conductor on the connector, and a gap exists between the protector and the hybrid connector to allow it to be inserted into the hybrid adapter is also disclosed.

The hybrid fiber and electrical connector and adapter system, wherein the conductors on the hybrid connector are flat conductive plates, and the conductors in the hybrid adapter are conductive leaf springs is also disclosed.

The hybrid fiber and electrical connector and adapter system, wherein the conductive leaf springs of the hybrid adapter have protrusion toward the conductive plates of the hybrid connector to allow good contact and provide a normal force between the conductive leaf springs and the conductive plates so that electrical power from the hybrid connector at one side of the hybrid adapter can be transferred to the hybrid connector at the other side of the hybrid adapter is also disclosed.

The hybrid fiber and electrical connector and adapter system, wherein the conductors in the hybrid adapter are flat conductive plates, and the conductors on the hybrid connector are conductive leaf springs is also disclosed.

The hybrid fiber and electrical connector and adapter system, wherein the conductive leaf springs on the hybrid conductors have protrusion toward the conductive plates of the hybrid adapter to allow good contact and provide a normal force between the conductive leaf springs and the conductive plates so that electrical power from the hybrid connector at one side of the hybrid adapter can be transferred to the hybrid connector at the other side of the hybrid adapter is also disclosed.

The hybrid fiber and electrical connector and adapter system, wherein the conductors of the connectors are connected to conductive sleeves, which can terminate the electrical wires of a field cable by crimping, is also disclosed.

The hybrid fiber and electrical connector and adapter system, wherein the conductors of the connectors are connected to conductive sleeves, which can terminate the electrical wires of a field cable by tightening the screw on the conductive sleeve is also disclosed.

The hybrid fiber and electrical connector, wherein the fiber optic connector features a stub fiber with one pre-polished end at the fiber optic connector's endface. In contrast, the stub fiber's other end can be seamlessly connected to a field fiber to install a fiber optic connector on a fiber optic cable is also disclosed.

The hybrid fiber and electrical adapter, wherein the hybrid adapter has shutters to prevent the ingress of dust and debris while safeguarding the eyes of workers or technicians involved in the installation or maintenance of a fiber optic system is also disclosed.

The hybrid fiber and electrical connector and adapter system, wherein the hybrid fiber and electrical connectors and adapter system can be installed on a patch panel or in a cassette is also disclosed.

A hybrid fiber and electrical connector containing at least one duplex fiber optic connector is provided, wherein the duplex connector has at least two conductors at the middle connector housing surface shared by both fiber optic connectors, whereby one conductor is on top of the other conductor is also disclosed.

The hybrid fiber and electrical connector, whereby at least one fiber optic connector is a duplex LC, CS, SN, or SC type is also disclosed.

The hybrid fiber and electrical connector, whereby at least one connector is a multifiber MTP/MPO type is also disclosed.

The hybrid fiber and electrical connector and adapter system, wherein an insulative protector is integrated into the top of the duplex connector to protect the user from touching the conductor on the connector, and a gap exists between the protector and the hybrid connector to allow it to be inserted into the hybrid adapter is also disclosed.

The hybrid fiber and electrical connector and adapter system, wherein an insulative protector is integrated into the bottom of the duplex connector to protect the user from touching the conductor on the connector, and a gap exists between the protector and the hybrid connector to allow it to be inserted into the hybrid adapter is also disclosed.

A duplex fiber optic adapter with at least two metal conductors in the middle of the adapter housing, wherein one conductor is on top of the other conductor is disclosed.

The hybrid fiber and electrical adapter, whereby the adapter is configured to house at least one fiber optic connector of the duplex LC, CS, SN, or SC type is also disclosed.

The hybrid fiber and electrical adapter, whereby the adapter is configured to house one multifiber fiber optic MTP/MPO connector type is also disclosed.

The present disclosure thus describes systems, devices, and methods for implementing a hybrid cable connector and adapter system and a method for utilizing the hybrid cable connector and adapter system. As is readily apparent from the foregoing, various non-limiting embodiments of the hybrid cable connector and adapter system, device, and methods for utilizing the hybrid cable connector and adapter system have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A hybrid cable connector comprising:
a first hybrid connector including a first wall surface, the first wall surface including a first pair of slots;
a second hybrid connector including a second wall surface, the second wall surface including a second pair of slots;
a first pair of conductive plates positioned within the first pair of slots;
a second pair of conductive plates positioned within the second pair of slots; and
a push-pull clip configured to hold the first hybrid connector and the second hybrid connector, the push-pull clip comprising an insulative protector configured to cover over at least a portion of the first hybrid connector and at least a portion of the second hybrid connector.

2. The hybrid cable connector of claim 1, wherein the first wall surface faces towards the second wall surface.

3. The hybrid cable connector of claim 1, wherein the first pair of slots are positioned to be vertically aligned, and the second pair of slots are positioned to be vertically aligned.

4. The hybrid cable connector of claim 1, wherein the insulative protector comprises a flat cover, a first side portion hanging down from the flat cover, and a second side portion hanging down from the flat cover.

5. The hybrid cable connector of claim 1, wherein the insulative protector is uniformly molded with the push-pull clip.

6. The hybrid cable connector of claim 1, wherein when the hybrid cable connector is installed into a hybrid adapter, the first pair of conductive plates is configured to contact a first pair of leaf springs included in a hybrid adapter and the second pair of conductive plates is configured to contact a second pair of leaf springs included in a hybrid adapter.

7. A hybrid cable connector adapter comprising:
a first side housing comprising a first opening configured to install a first hybrid connector and a second opening configured to install a second hybrid connector;
a second side housing comprising a third opening configured to install a third hybrid connector and a fourth opening configured to install a fourth hybrid connector;
a first set of leaf springs configured to:
contact a first pair of conductive plates included on the first hybrid connector installed into the first opening of the first side housing; and
contact a third pair of conductive plates included on the third hybrid connector installed into the third opening of the second side housing;
a second set of leaf springs configured to:
contact a second pair of conductive plates included on the second hybrid connector installed into the second opening of the first side housing; and
contact a fourth pair of conductive plates included on the fourth hybrid connector installed into the fourth opening of the second side housing; and
a first fiber optic transmission tunnel configured to transfer an optical signal from the first hybrid connector to the third hybrid connector; and
a second fiber optic transmission tunnel configured to transfer an optical signal from the second hybrid connector to the fourth hybrid connector.

8. The hybrid cable connector adapter of claim 7, wherein the first set of leaf springs are positioned in a stacked vertical orientation.

9. The hybrid cable connector adapter of claim 7, wherein the second set of leaf springs are positioned in a stacked vertical orientation.
